(19) United States
(12) Patent Application Publication
(10) Pub. No.: US 2024/0149345 A1
(43) Pub. Date: May 9, 2024

(54) MICROWAVE IRRADIATION APPARATUS AND METHOD OF PRODUCING METAL NANOPARTICLES

(71) Applicant: TOYOTA JIDOSHA KABUSHIKI KAISHA, Toyota-shi (JP)

(72) Inventors: Reimi YAMADA, Nagoya-shi (JP); Jyunya MURAI, Nisshin-shi (JP)

(73) Assignee: TOYOTA JIDOSHA KABUSHIKI KAISHA, Toyota-shi (JP)

(21) Appl. No.: 18/383,737

(22) Filed: Oct. 25, 2023

(30) Foreign Application Priority Data
Nov. 8, 2022 (JP) 2022-178728

(51) Int. Cl. B22F 9/24; B01J 19/12; B22F 1/054

(52) U.S. Cl. CPC B22F 9/24; B01J 19/126; B22F 1/054; B01J 2219/1269; B01J 2219/1296; B22F 2202/11

(57) ABSTRACT

There are provided a microwave irradiation apparatus and a production method of metal nanoparticles for producing the metal nanoparticles that allow efficiently preparing the metal nanoparticles having small and uniform particle sizes. The present disclosure relates to the microwave irradiation apparatus that includes two microwave irradiation sources, two waveguides, and one reaction portion. The two microwave irradiation sources are disposed such that respective microwave emission units thereof face one another. The two microwave irradiation sources, the two waveguides, and the one reaction portion are disposed such that respective microwaves emitted from the two microwave irradiation sources pass through the two waveguides and contact an entire surface of the one reaction portion. Furthermore, the reaction portion is adjusted to have a specific size.

### CROSS REFERENCE TO RELATED APPLICATIONS

The present application claims priority from Japanese patent application JP 2022-178728 filed on Nov. 8, 2022, the entire content of which is hereby incorporated by reference into this application.

### BACKGROUND

### Technical Field

The present disclosure relates to a microwave irradiation apparatus and a method of producing metal nanoparticles.

### Description of Related Art

Recently, metal nanoparticles which may have properties different from a bulk material have been used for various applications, such as a catalyst and electronic component members.

Additionally, various apparatuses and methods for producing metal nanoparticles are devised. Among them, a production apparatus and a production method of metal nanoparticles using a microwave gather attention as ones that allow synthesizing metal nanoparticles in a short time.

As the production apparatus of metal nanoparticles, for example, JP 2016-007566 A discloses a chemical reaction apparatus that includes a reactor, microwave generators that generate microwaves, and waveguides that transmit the microwaves generated by the microwave generators to an unfilled space in the reactor. The reactor is a horizontal flow-type. In the reactor, a liquid content horizontally flows with the unfilled space being provided thereabove. Inside of the reactor is partitioned into multiple chambers by a partition plate. One kind of the partition plate is an overflow-type partition plate in which the content passes through thereover. One kind of the partition plate is an underflow-type partition plate in which the content passes through thereunder.

JP 2020-080298 A discloses a microwave processing apparatus that includes a cavity resonator, a microwave supply means, and a control unit. The microwave processing apparatus processes an object to be processed using a single mode standing wave. The single mode standing wave is a standing wave in a TMₘₙ₀ (m and n are integers of one or more) or a TEₘ₀ₚ (m and p are integers of one or more) mode. The cavity resonator forms the single mode standing wave. The microwave supply means supplies a microwave matching a resonance frequency of the single mode standing wave to the inside of the cavity resonator. The control unit controls the frequency of the microwave supplied by the microwave supply means based on the resonance frequency of the cavity resonator. In the microwave processing apparatus, the object to be processed is disposed along a position where a magnetic field strength becomes a local maximum.

### SUMMARY

In an electronics implementation field as well, metal nanoparticles have been examined as a high heat resistance bonding material. Examples of the high heat resistance bonding material include a lead-free bonding material (such as a lead-free solder) that allows bonding at a low temperature. Usually, bonding with the lead-free solder at 250° C. or less is difficult. However, the lead-free solder containing metal nanoparticles has a melting point lower than a bulk material as the property of the metal nanoparticles. Meanwhile, when the lead-free solder containing metal nanoparticles is used for bonding and sintered, the lead-free solder has a melting point as the bulk material. Accordingly, the lead-free solder containing metal nanoparticles allows bonding at 250° C. or less.

To use metal nanoparticles as the high heat resistance bonding material, the melting point of the metal nanoparticles needs to be constant. To make the melting point of the metal nanoparticles constant, it is desirable that the particle sizes of the metal nanoparticles are decreased and further the particle size distribution is narrowed.

Although development of metal nanoparticles applicable to the various applications has been advancing, it is difficult to prepare metal nanoparticles having small and uniform particle sizes in a method of producing metal nanoparticles that irradiates a reaction solution with a microwave. Here, the uniform particle sizes mean the narrow particle size distribution.

Therefore, the present disclosure provides a microwave irradiation apparatus for producing metal nanoparticles (production apparatus of metal nanoparticles) and a method of producing metal nanoparticles that allow efficiently prepare the metal nanoparticles having small and uniform particle sizes.

In the related art, in a production apparatus and a production method of metal nanoparticles in a flow type, metal nanoparticles are mass-produced as follows.
(i) An inner diameter of a reaction path in a production apparatus of metal nanoparticles is identified.
(ii) A single mode standing wave of a microwave is used.
(iii) Stirring is performed using a partition plate.

However, in the production apparatus and the production method of metal nanoparticles, when a volume of irradiating a microwave was increased to improve the productivity, the particle sizes of the metal nanoparticles to be synthesized varied to deteriorate the quality in some cases.

Additionally, for example, there is a possibility of poor yield of the metal nanoparticles due to incompletion of the synthesis reaction in association with the increase in the reaction flow passage in the flow type.

The inventors have variously examined the cause of the variation in the particle size of the metal nanoparticles to be synthesized, leading to the deterioration of quality when the volume of irradiating the microwave was increased to improve the productivity in the method of producing metal nanoparticles. As a result, the inventors have found that, in the method of producing metal nanoparticles by irradiating the reaction solution with the microwave, there are a part that is irradiated with the microwave and a part that is not irradiated with the microwave in the reaction solution. This possibly occurs due to a property of sparseness and density specific to the wave of the microwave. Note that the part that is irradiated with the microwave is a part where the reaction solution absorbs the microwave. The part that is not irradiated with the microwave is a part where the reaction solution does not absorb the microwave.

With reference to FIG. 1A and FIG. 1B, FIG. 1A and FIG. 1B illustrate absorption intensity of the microwave when the reaction solution is irradiated with the microwave. In FIG. 1A, the volume of the reaction solution (also referred to as a “reaction portion” in this specification or the like) is 1 ml, and the variation in the intensity of microwave hardly exists in the reaction portion. Meanwhile, in FIG. 1B, the reaction portion is 10 ml and the variation in the intensity of microwave exists in the reaction portion.

FIG. 2 schematically illustrates a degree of penetration of the microwave at the surface and the inside of the reaction solution when the reaction solution is irradiated with the microwave. From FIG. 2, the microwave penetrates up to the part of several mm from the surface of the irradiated reaction solution. In other words, the microwave does not penetrate up to the part that is lower than the part of several mm from the surface of the irradiated reaction solution. The reaction solution cannot absorb the microwave at the part where the microwave does not penetrate.

Therefore, the inventors have variously examined means to solve the problems. As a result, the inventors have found that, in a method of producing metal nanoparticles by irradiating a reaction solution with a microwave, when a microwave irradiation source, a reaction portion, and a reaction mode are adjusted as follows, the metal nanoparticles having small and uniform particle sizes are able to be efficiently prepared, thus completing the present disclosure.
(i) The two microwave irradiation sources are disposed such that respective microwave emission units thereof face one another.
(ii) The reaction portion irradiated with the microwave is adjusted such that an area (an orthogonal projection area) of a surface perpendicular to a microwave traveling direction (z-axis direction) (a surface expanding in an x-axis and a y-axis of the reaction portion when the reaction portion is viewed in the z-axis direction (xy plane)) becomes larger than respective areas (orthogonal projection areas) of surfaces parallel to the microwave traveling direction (a surface expanding in the x-axis and the z-axis of the reaction portion when the reaction portion is viewed in the y-axis direction (xz plane) and a surface expanding in the y-axis and the z-axis of the reaction portion when the reaction portion is viewed in the x-axis direction (yz surface)).
(iii) An irradiation step of the reaction solution with the microwave is a batch type.

That is, the gist of the present disclosure is as follows.
(1) A microwave irradiation apparatus comprises two microwave irradiation sources, two waveguides, and one reaction portion. The two microwave irradiation sources are disposed such that respective microwave emission units thereof face one another. The two microwave irradiation sources, the two waveguides, and the one reaction portion are disposed such that respective microwaves emitted from the two microwave irradiation sources pass through the two waveguides and contact an entire surface of the one reaction portion. When a microwave traveling direction is a z-axis direction and directions perpendicular to the microwave traveling direction are an x-axis direction and a y-axis direction, an orthogonal projection area of a surface (xy plane) expanding in an x-axis and a y-axis in the reaction portion when viewed in the z-axis direction is larger than each of orthogonal projection areas of a surface (xz plane) expanding in the x-axis and a z-axis in the reaction portion when viewed in the y-axis direction and a surface (yz plane) expanding in the y-axis and the z-axis in the reaction portion when viewed in the x-axis direction.
(2) In the microwave irradiation apparatus according to (1), z-axis lengths of the xz plane and the yz plane in the reaction portion are twice or less of a penetration depth of one microwave into the reaction portion.
(3) In the microwave irradiation apparatus according to (1) or (2), the orthogonal projection area of the xy plane in the reaction portion is from 100 mm² to 3850 mm².
(4) A method of producing metal nanoparticles including irradiating a reaction solution with a microwave comprises: (i) preparing two microwave irradiation sources and disposing respective microwave emission units of the two microwave irradiation sources such that the respective microwave emission units face one another; (ii) disposing the reaction solution between the two microwave irradiation sources; and (iii) irradiating an entire surface of the reaction solution with two microwaves from the two microwave irradiation sources by a batch type. When a microwave traveling direction is a z-axis direction and directions perpendicular to the microwave traveling direction are an x-axis direction and a y-axis direction, an orthogonal projection area of a surface (xy plane) expanding in an x-axis and a y-axis in the reaction portion when viewed in the z-axis direction is adjusted to be larger than each of orthogonal projection areas of a surface (xz plane) expanding in the x-axis and a z-axis in the reaction portion when viewed in the y-axis direction and a surface (yz plane) expanding in the y-axis and the z-axis in the reaction portion when viewed in the x-axis direction.
(5) In the method according to (4), the reaction solution is not physically stirred in (iii).
(6) In the method according to (4) or (5), z-axis lengths of the xz plane and the yz plane in the reaction solution are twice or less of a penetration depth of one microwave into the reaction solution in (iii).
(7) In the method according to any one of (4) to (6), the orthogonal projection area of the xy plane in the reaction solution is from 100 mm² to 3850 mm² in (iii).

The present disclosure provides the microwave irradiation apparatus for producing the metal nanoparticles and the method of producing the metal nanoparticles that allow efficiently preparing the metal nanoparticles having small and uniform particle sizes.

### BRIEF DESCRIPTION OF THE DRAWINGS

FIG. 1A is a drawing illustrating an absorption intensity of a microwave in a reaction solution when the reaction solution with a volume of 1 ml is irradiated with the microwave;

FIG. 1B is a drawing illustrating an absorption intensity of a microwave in a reaction solution when the reaction solution with a volume of 10 ml is irradiated with the microwave;

FIG. 2 schematically illustrates a degree of penetration of a microwave at a surface and an inside of a reaction solution when the reaction solution is irradiated with the microwave;

FIG. 3 is a drawing schematically illustrating one embodiment of a microwave irradiation apparatus of the present disclosure; and

FIG. 4A and FIG. 4B are graphs showing particle size distributions of silver nanoparticles obtained in Example 1 and Comparative Example 1.

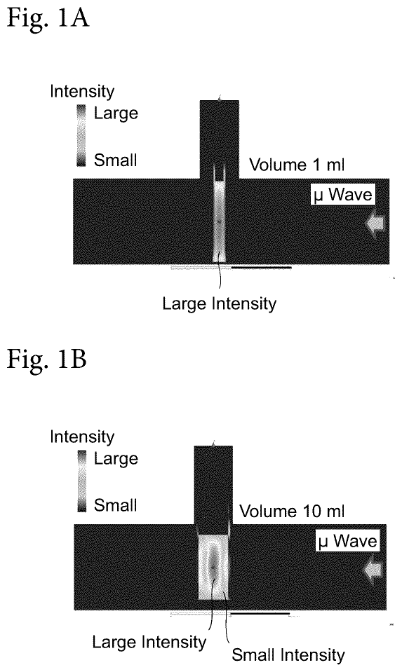

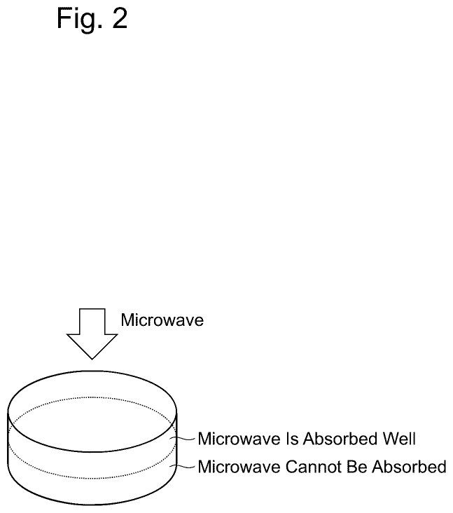

### DETAILED DESCRIPTION OF THE EMBODIMENTS

The following describes some embodiments of the present disclosure in detail. In the description, features of the present disclosure will be described with reference to the drawings as necessary. In the drawings, dimensions and shapes of respective components are exaggerated for clarification, and actual dimensions and shapes are not accurately illustrated. Accordingly, the technical scope of the present disclosure is not limited to the dimensions or the shapes of the respective components illustrated in the drawings. Note that a microwave irradiation apparatus or a method of producing metal nanoparticles of the present disclosure is not limited to the embodiments below, and can be performed in various configurations where changes, improvements, and the like that a person skilled in the art can make are given without departing from the gist of the present disclosure.

The present disclosure relates to a method of producing metal nanoparticles including a step of irradiating a reaction solution with a microwave. In the method of the present disclosure, two microwave irradiation sources are prepared as a step (i). Here, microwave emission units of the two microwave irradiation sources are disposed so as to face one another. In a step (ii), the reaction solution is disposed between the two microwave irradiation sources. In a step (iii), the entire surface of the reaction solution is irradiated with two microwaves from the two microwave irradiation sources. Here, when a microwave traveling direction is a z-axis direction and directions perpendicular to the microwave traveling direction are an x-axis direction and a y-axis direction, “the entire surface of the reaction solution” means that a total orthogonal projection area of an xy plane formed by the two microwaves from the two microwave irradiation sources is larger than an orthogonal projection area of an xy plane of the reaction solution, when viewed in the z-axis direction. In the following description as well, the relationship among the x-axis, the y-axis, and the z-axis are as described above, and the description of the relationship may be omitted. Note that, as described later, an orthogonal projection area of the xy plane of each of the microwaves depends on an orthogonal projection area of an xy plane of a waveguide through which the microwaves pass. Additionally, the step (iii) is performed by a batch type. Furthermore, the orthogonal projection area of the surface (xy plane) expanding in the x-axis and the y-axis in the reaction portion when viewed in the z-axis direction is adjusted to be larger than each of orthogonal projection areas of a surface (xz plane) expanding in the x-axis and the z-axis in the reaction portion when viewed in the y-axis direction and a surface (yz plane) expanding in the y-axis and the z-axis in the reaction portion when viewed in the x-axis direction. Here, “the orthogonal projection area of the xy plane is larger than the orthogonal projection areas of the xz plane and the yz plane” means that, in other words, an area of the xy plane at any position on the z-axis becomes larger than an area of the xz plane at any position on the y-axis and an area of the yz plane at any position on the x-axis in the reaction solution.

Here, the reaction solution used in the present disclosure is not limited. As the reaction solution, the configuration of the reaction solution that can be used in the conventional method that produces metal nanoparticles by irradiating the microwave can be used. For example, examples of materials contained in the reaction solution are as follows.

First, the reaction solution contains raw materials of the metal nanoparticles. The metal nanoparticles include noble metal nanoparticles, base metal nanoparticles and alloy nanoparticles, for example, gold nanoparticles, silver nanoparticles, platinum nanoparticles, copper nanoparticles, nickel nanoparticles, iron nanoparticles, cobalt nanoparticles, and alloy nanoparticles of these metals. In one embodiment, the metal nanoparticles are silver nanoparticles. As long as the raw material of the metal nanoparticles is dissolved in a solvent and metal ions can be generated, the raw material of the metal nanoparticles is not limited. Examples of the raw material of the metal nanoparticles include inorganic salt of metal, such as hydrochloride of metal, sulfate of metal, nitrate of metal, and phosphate of metal, organic salt of metal, such as carboxylate of metal and sulfonate of metal, and a complex of metal including a complex salt of metal. For example, the raw material of the metal nanoparticles may be prepared by dissolving a material containing metal and/or metal salt with acid, such as nitric acid, or base, such as ammonia water. In one embodiment, as the raw material of the metal nanoparticles, low-price nitrate, such as silver nitrate, is used.

The concentration of metal ions in the reaction solution is not limited. The concentration of metal ions in the reaction solution is usually from 0.1 mmol/L (mM) to 300 mM and from 0.1 mM to 100 mM in one embodiment.

By setting the concentration of the metal ions in the reaction solution in the ranges, the variation in the obtained metal nanoparticles decreases, in other words, the particle size distribution of the obtained metal nanoparticles narrows.

Furthermore, the reaction solution contain a solvent. The solvent used for the reaction solution can dissolve and disperse materials, such as the raw material of the metal nanoparticles, a protective agent and a reductant. Furthermore, the solvent used for the reaction solution can absorb the microwave. Accordingly, in one embodiment, the solvent used for the reaction solution is a polar solvent and an ionic liquid. Additionally, an example of the solvent used for the reaction solution includes a low-boiling-point solvent with a boiling point of 300° C. or less. The low-boiling-point solvent is not limited. Examples of the low-boiling-point solvent include a low-boiling-point polar solvent, such as water, alcohol, such as methanol and ethanol, a polyhydric alcohol solvent, such as ethylene glycol, a ketone solvent, such as acetone, dimethylsulfoxide (DMSO), N,N-dimethylformamide (DMF), the other organic solvent, or a mixture of two or more kinds of them. In one embodiment, the solvent used for the reaction solution is water.

The use of the low-boiling-point solvent as the solvent used for the reaction solution allows improving handleability of the solvent and decreasing a load on the environment.

Furthermore, the reaction solution contains the protective agent. The protective agent used for the reaction solution is a compound that is bonded to a part of or the whole surfaces of the surfaces of the metal nanoparticles generated in the reaction solution to suppress aggregation between the metal nanoparticles. The protective agent is not limited. Examples of the protective agent include polyvinylpyrrolidone (PVP), a thiol polymer, polyvinyl alcohol (PVA), and tannic acid. In one embodiment, the protective agent is PVP.

The amount of the protective agent is not limited and can be changed according to the desired particle sizes of the metal nanoparticles. The amount of the protective agent is usually from 0.1 times to 20 times and from 0.2 times to 10 times in one embodiment of the mole number of the metal.

The use of the protective agent allows suppressing the aggregation between the generated metal nanoparticles.

Furthermore, the reaction solution contains a reductant. The reductant is a material that can reduce the metal ions to metal with an oxidation number of 0 by redox reaction.

The reductant is not limited. The reductant includes, for example, citric acid or citrate, for example, trisodium citrate, disodium citrate, monosodium citrate, oxalic acid or oxalate, for example, sodium oxalate, ascorbic acid or ascorbate, for example, sodium ascorbate, DMF, and a mixture of two or more kinds of them. In one embodiment, the reductant of metal ions, especially silver ions, is DMF.

As long as the reductant can reduce the metal ions to the metal with the oxidation number of 0 by redox reaction, the amount of reductant is not limited. The amount of reductant is usually from 1.0 times equivalent to 20 times equivalent and from 4.0 times equivalent to 15 times equivalent in one embodiment to the metal ions. Note that when the reductant of metal ions contains one or more kinds of a functional group that can interact with metal, such as a carboxy group, a hydroxy group, and an ether group, the reductant of metal ions can also act as a protective agent. When the reductant also acts as the protective agent, the protective agent describe above need not be contained in the reaction solution. Additionally, in the case, the amount of reductant of metal ions may be an amount exceeding the amount required to reduce the metal ions to the metal with the oxidation number of 0 by redox reaction.

The reaction solution may be constituted of the raw material of the metal nanoparticles, the solvent, the protective agent, and the reductant described above. In one embodiment, the reaction solution can contain an additive in addition to these materials. The additive is an additive that can be usually used in the reaction solution that can be used in the conventional method that produces metal nanoparticles by irradiating the microwave.

For example, the reaction solution may further contain a chelating agent, for example, ethylenediaminetetraacetic acid (EDTA) and/or ethylenediamine tetraacetate as the additive.

The pH of the reaction solution is not limited. The pH of the reaction solution is usually from pH 3 to pH 12.

The present disclosure does not limit the order of addition, the addition temperature, the mixture method, the mixture time, and the like of the respective materials to prepare the reaction solution. In the present disclosure, the reaction solution is mixed such that the uniform reaction solution is prepared. In the present disclosure, the reaction is started after preparation of the uniform reaction solution.

In the present disclosure, the two microwave irradiation sources emit the microwaves to the above-described reaction solution. The two microwave irradiation sources are disposed such that the microwave emission units of the respective microwave irradiation sources face one another. Accordingly, the reaction solution is disposed between the two microwave irradiation sources and the entire surface of the reaction solution is irradiated with the microwaves emitted from the respective microwave irradiation sources.

When the two microwave irradiation sources are used to irradiate the reaction solution and the reaction solution is irradiated with the microwaves from the front and the back of the reaction solution, the microwaves can evenly spread not only the surface region but also the inner region of the reaction solution.

It is only necessary that, as the relative positions of the two microwave irradiation sources, the microwave emission units of the respective microwave irradiation sources face one another. The relative positions of the two microwave irradiation sources can be taken from positions where the waveguides through which the microwaves pass completely overlap with one another linearly to the positions where the surfaces (xy planes) expanding in the x-axis and the y-axis in the waveguides just do not overlap with one another, when viewed in the z-axis direction. The relative positions of the two microwave irradiation sources can be configured such that, for example, when viewed in the z-axis direction, the orthogonal projection area where the xy planes in the two waveguides overlap with one another is usually from 12% to 100% and from 12% to 51% in one embodiment to the total orthogonal projection area of the xy plane formed by the two waveguides. Note that the shape of the waveguide is not limited, and for example, a pillar-shaped body, for example, a rectangular parallelepiped, a cylindrical body, and a polygonal prism body can be employed. The microwave determines the irradiation range depending on the shape of the waveguide.

By configuring the positions of the two microwave irradiation sources to be as described above, the volume of the reaction solution that can be irradiated with the microwaves can be increased.

To allow irradiation of the entire surface of the reaction solution with the two microwaves from the two microwave irradiation sources, the reaction solution irradiated with the microwaves is adjusted such that the orthogonal projection area of the surface (xy plane) expanding in the x-axis and the y-axis in the volume of the reaction solution, that is, the reaction portion when viewed in the z-axis direction becomes larger than each of the orthogonal projection areas of the surface (xz plane) expanding in the x-axis and the z-axis in the reaction portion when viewed in the y-axis direction and the surface (yz plane) expanding in the y-axis and the z-axis in the reaction portion when viewed in the x-axis direction.

Usually, from an aspect of keeping the reaction solution uniformly, stirring with a stirrer or a stirring bar is required in the reaction. For example, the flow (distribution) type requires transport of the reaction solution (flow rate control of the reaction solution). However, identifying the reaction portion as described above allows penetrating the microwaves to the entire reaction portion. Accordingly, it is avoided that the nuclei of the metal nanoparticles formed in the parts irradiated with the microwaves are coarsened by the raw material of the metal nanoparticles existing in parts not irradiated with the microwave and in which nuclei of the metal nanoparticles are still unformed. Accordingly, in the present disclosure, even when the reaction solution is not physically stirred during the reaction, the particle sizes of the obtained metal nanoparticles can be kept to small and uniform.

As long as the xy plane, the xz plane, and the yz plane are identified as described above, the shape of the reaction portion is not limited. The shape of the reaction portion is a shape having a surface smaller than the surface of the irradiated microwave (the surface when the microwave contacts the reaction solution and/or the xy plane of the waveguide when viewed in the z-axis direction), and, for example, a sphere and a pillar-shaped body, for example, a rectangular parallelepiped, a cylindrical body (pipe-shaped body), and a polygonal prism body can be employed.

The z-axis lengths of the xz plane when viewed in the y-axis direction and the yz plane when viewed in the x-axis direction in the reaction portion are determined based on a penetration depth of the microwave irradiated from one microwave irradiation source into the reaction solution.

A penetration depth D of one microwave into the reaction solution can be expressed by the following formula.

$$D = \frac{3.31 \times 1 {0}^{7}}{f \sqrt{{ε}_{r}} \cdot tan δ} [ m ] \qquad [ Math . 1 ]$$

In the formula, f indicates a frequency [Hz] of the microwave, Fr indicates a relative dielectric constant of a dielectric, and tan δ is a dielectric loss angle of the dielectric. The reaction portion is irradiated with the two microwaves. Accordingly, the maximum value of the z-axis length is twice the penetration depth D of one microwave into the reaction solution. For example, when the solvent of the reaction solution is water (5° C.) and the frequency of the microwave is 2.45 GHz, the maximum value of the z-axis length is 10 mm. For example, when the solvent of the reaction solution is water (5° C.), the z-axis length depends on the frequency of the microwave and is usually adjusted from 5 mm to 26 mm and from 5 mm to 10 mm in one embodiment.

The orthogonal projection area of the xy plane in the reaction portion when viewed in the z-axis direction is usually from 1% to 33% and 22% in one embodiment to the irradiation orthogonal projection area (the total orthogonal projection area of the xy plane formed by the two waveguides when viewed in the z-axis direction) of the microwaves irradiated from the two microwave irradiation sources to the reaction portion. For example, the orthogonal projection area of the xy plane in the reaction portion when viewed in the z-axis direction is usually from 100 mm² to 3850 mm² and 2640 mm² in one embodiment.

The reaction portion can be formed as a container housing the reaction solution. Accordingly, the reaction portion is the container that houses the reaction solution adjusted to have the area relationship of the respective surfaces described above. The reaction portion may be installed in a reaction chamber installed between the two microwave irradiation sources. The material of the container housing the reaction solution is not limited as long as the reaction solution can be uniformly irradiated with the microwave. As the material of the part of the container housing the reaction solution through which the reaction solution is irradiated with the microwave, a material that transmits the microwave, for example, ceramic, glass (quartz), and the like are used.

The step of irradiating the reaction solution with the microwave is performed by the batch type. That is, the step is performed in a state where the reaction solution is not transported. In other words, the reaction solution that is not transported is irradiated with the microwave.

Performing the step of irradiating the reaction solution with the microwave by the batch type allows completing the synthesis reaction itself and allows improving a yield and productivity. Furthermore, in the reaction by the batch type, a problem of obstruction of the metal nanoparticles that possibly occurs in the flow type when the raw material of the metal nanoparticles has a high concentration is less likely to occur.

When the reaction solution is irradiated with the microwave, the solvent contained in the reaction solution absorbs the microwave and generates heat through conversion into heat energy. Accordingly, in the reaction solution irradiated with the microwave, a uniform and quick temperature rise occurs in the irradiated part. With the reaction solution, in accordance with the temperature rise, the uniform and quick reaction occurs.

The microwave is generated from the microwave irradiation source (microwave oscillator (magnetron)). The microwave irradiation source can be used in both of a single mode system and a multi-mode system. In one embodiment, the microwave irradiation source is a single mode system used in Sim.

The output from each of the two microwave irradiation sources is not limited. The output from the microwave irradiation source is usually from 1 W to 6000 W.

By adjusting the respective outputs from the two microwave irradiation sources in the range, the metal nanoparticles with the small and uniform particle sizes can be prepared with the microwaves by the existing output.

The frequency of each of the microwaves generated from the two microwave irradiation sources can be appropriately changed and is not limited. The frequency of the microwave is usually from 0.9 GHz to 10 GHz, and from 2 GHz to 6 GHz in one embodiment. In one embodiment, as the frequency of the microwave, 2.45 GHz, which is a frequency of an industrial microwave power source, is used.

In one embodiment, the microwave is uniform during irradiation. In one embodiment, the irradiation conditions of the microwave are constant during irradiation with the microwave.

In the present disclosure, the temperature of the reaction solution increased by the irradiations with the microwaves is a reaction temperature. The reaction temperature can be appropriately changed by the condition for reaction (such as the kind of metal, the kind of solvent, and the pressure during the reaction) and is not limited. The reaction temperature is usually 25° C. or more and 80° C. or more in one embodiment. The upper limit of the reaction temperature is not limited. In one embodiment, the upper limit of the reaction temperature is usually less than the boiling point of the solvent. When the solvent is water, the reaction temperature is, for example, usually in the range of 25° C. or more and less than 100° C. and from 80° C. to 90° C. in one embodiment under atmospheric pressure.

Setting the reaction temperature to 25° C. or more causes reduction reaction from metal ions to the metal nanoparticles. Meanwhile, when the reaction solution boils, a reaction field becomes non-uniform. When the reaction field becomes non-uniform, the particle sizes of the generated metal nanoparticles become varied and as a result, the particle size distribution possibly expands. Accordingly, by setting the reaction temperature to less than the boiling point of the solvent, the expansion of the particle size distribution can be avoided. Accordingly, by setting the reaction temperature within the range, the metal nanoparticles with the small and uniform particle sizes can be prepared.

The irradiation time of the reaction solution with the microwave is time taken until the temperature of the reaction solution reaches the reaction temperature. The irradiation time of the microwave is appropriately changed by the reaction condition (such as the condition for microwave, the kind of metal, the kind of solvent, the pressure during the reaction, the amount of reaction solution, and the reaction temperature) and is not limited. The irradiation time of the microwave is usually from 0.1 seconds to 300 seconds and from 10 seconds to 60 seconds in one embodiment.

By irradiating the reaction solution with the microwave under the conditions as described above to reach the temperature of the reaction solution to the reaction temperature, the nuclei of the metal nanoparticles and further the metal nanoparticles are generated in the reaction solution.

Note that the completion of reaction can be determined by observing, for example, absorbance derived from the raw material of the metal nanoparticles or the metal nanoparticles in the reaction solution. For example, when the metal nanoparticles are silver nanoparticles and inorganic salt is used as the raw material of the silver nanoparticles, a change in absorbance from 280 nm to 780 nm of the reaction solution in association with a temperature retention time is observed and a time point at which the absorbance does not change is determined as a time point of the completion of reaction. Alternatively, a change in absorbance from 280 nm to 780 nm derived from the silver nanoparticles in the reaction solution in association with the temperature retention time is observed and a time point at which the absorbance does not change is determined as the time point of the completion of reaction.

In the present disclosure, as described above, the reaction solution does not need to be stirred by, for example, a stirring mechanism, for example, a propeller stirrer, a vibration stirrer, and a magnet stirrer.

Even when the reaction solution is not stirred, since the reaction portion during the microwave irradiation is regulated to have the constant shape, the reaction portion is uniformly irradiated with the microwaves. Consequently, the metal nanoparticles are uniformly generated in the reaction solution and the reaction solution can be uniformly kept.

While the present disclosure is performed by the batch type, a stirring function is unnecessary. Accordingly, the present disclosure can be performed using a flow type synthesizing apparatus. When the flow type synthesizing apparatus is used, the present disclosure is performed, for example, as follows. First, the reaction solution is housed in the reaction portion provided in the microwave irradiation apparatus of the present disclosure described above or described later. Secondly, in a state where the reaction solution does not flow, that is, in a state of stopping transporting the reaction solution, the reaction is performed. Thirdly, after the completion of reaction, the reaction solution is sent out (transported). When the present disclosure is thus performed, the transport of the reaction solution needs to be stopped during the reaction. However, since the reaction solution can be promptly transported after the completion of reaction, the metal nanoparticles can be continuously synthesized. Additionally, since the generation and transport of the metal nanoparticles are independent from one another, the transport speed can be increased. Accordingly, the obstruction of the pipe by the generated metal nanoparticles can be avoided.

The present disclosure also relates to the microwave irradiation apparatus that allows efficiently performing the method of producing metal nanoparticles described above. Accordingly, the microwave irradiation apparatus of the present disclosure includes the two microwave irradiation sources, the two waveguides, and one reaction portion. The two microwave irradiation sources are disposed so as to face the respective microwave emission units one another. The two waveguides are disposed such that the respective microwaves emitted from the two microwave irradiation sources pass through. The one reaction portion is disposed at ends opposite to the microwave irradiation sources in the two waveguides. Accordingly, the two microwave irradiation sources, the two waveguides, and the one reaction portion are disposed such that the respective microwaves emitted from the two microwave irradiation sources pass through the two waveguides and contact the entire surface of the one reaction portion. The one reaction portion is set such that, when the microwave traveling direction is the z-axis direction and directions perpendicular to the microwave traveling direction are the x-axis direction and the y-axis direction, the orthogonal projection area of the surface (xy plane) expanding in the x-axis and the y-axis in the reaction portion when viewed in the z-axis direction becomes larger than each of the orthogonal projection areas of the surface (xz plane) expanding in the x-axis and the z-axis in the reaction portion when viewed in the y-axis direction and the surface (yz plane) expanding in the y-axis and z-axis in the reaction portion when viewed in the x-axis direction.

Details of the two microwave irradiation sources, the two waveguides, and the one reaction portion of the microwave irradiation apparatus of the present disclosure are as described above.

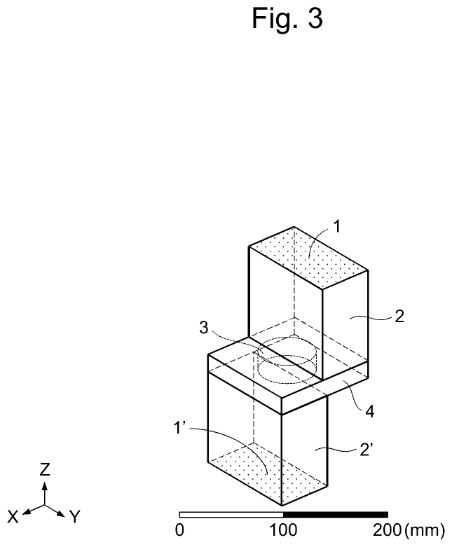

FIG. 3 schematically illustrates the microwave irradiation apparatus according to one embodiment of the present disclosure. The microwave irradiation apparatus illustrated in FIG. 3 is configured in accordance with the microwave irradiation apparatus of the present disclosure described above. Accordingly, the microwave irradiation apparatus of the present disclosure includes two microwave irradiation sources 1 and 1′, two waveguides 2 and 2′, and one reaction portion 3. One reaction portion 3 is installed inside a reaction chamber 4 installed between the two microwave irradiation sources 1 and 1′ (between the two waveguides 2 and 2′). The respective shapes of the two waveguides 2 and 2′ are rectangular parallelepipeds. The xy planes in the two waveguides 2 and 2′ partially overlap when viewed in the z-axis direction. The shape of one reaction portion 3 is the cylindrical body.

For a dispersion liquid containing the metal nanoparticles obtained by the production apparatus or the production method of metal nanoparticles of the present disclosure, for example, separation and purification (for example, salting-out and centrifuge) are performed by the method known in the technical field as necessary, thus allowing obtaining the objective metal nanoparticles and/or dispersion liquid containing the metal nanoparticles.

The metal nanoparticles produced by the production apparatus or the production method of metal nanoparticles of the present disclosure feature that the particle sizes are small and the dispersion of the particle size distribution is small.

The mean particle size of the metal nanoparticles can be measured by a TEM image and/or absorbance of the dispersion liquid containing the metal nanoparticles. When the mean particle size of the metal nanoparticles is measured by the absorbance, the smaller the maximum value of the peak of the absorbance is, the smaller the mean particle size becomes. When, for example, the silver nanoparticles are used as the metal nanoparticles, the mean particle size of the metal nanoparticles, namely, the mean particle size of the silver nanoparticles is usually 30 nm or less and from 1 nm to 20 nm in one embodiment.

The particle size distribution of the metal nanoparticles can be grasped by the TEM image and/or a half-value width of the peak of the absorbance of the dispersion liquid containing the metal nanoparticles. When the particle size distribution of the metal nanoparticles is measured by the half-value width of the peak of the absorbance, the smaller the half-value width is, the narrower the particle size distribution becomes, that is, the smaller the variation in the particle size becomes. Note that the half-value width of the peak of the absorbance of the dispersion liquid containing the metal nanoparticles indicates a distance (width) between wavelengths at two points of the absorbance half of the maximum value of the peak of the absorbance. For example, when silver nanoparticles are used as the metal nanoparticles, the half-value width of the peak of the absorbance of the dispersion liquid containing the silver nanoparticles produced by the method of the present disclosure becomes smaller than a half-value width of a peak of absorbance of a dispersion liquid containing silver nanoparticles produced by the conventional synthetization with microwaves. That is, the silver nanoparticles produced by the method of the present disclosure are the uniform silver nanoparticles with the narrow particle size distribution (the variation in the particle size is small and the particle sizes are uniform).

The metal nanoparticles produced by the method of producing metal nanoparticles of the present disclosure can be used as a high heat resistance bonding material of an electronic component and a wiring material because of a property of sinterable at low temperature, in addition to the conventional catalyst, electronic component member, or the like.

### EXAMPLES

While the following describes some examples regarding the present disclosure, it is not intended to limit the present disclosure to those described in such examples.

1. Preparation of Silver Nanoparticles

### Example 1

To 25 ml of water as a polar solvent, 0.85 g of silver nitrate as a raw material of the silver nanoparticles, 3.33 g of PVP as a protective agent, and 25 ml of DMF as a reductant were added, and the respective materials were dissolved in the water to prepare a reaction solution.

The obtained reaction solution was introduced into a reaction vessel in the apparatus having the configuration of FIG. 3. Without stirring, the reaction solution was caused to absorb a microwave with a power density of 10 W/mL based on the total volume of the reaction solution from each of the two microwave irradiation sources. The temperature of the reaction solution was reached to 90° C., and the reaction was performed for 10 minutes to obtain the silver nanoparticles.

Note that the reaction vessel during the reaction of Example 1 satisfied the requirements of the reaction portion of the apparatus of FIG. 3 as described above. Accordingly, when the microwave traveling direction was the z-axis direction and directions perpendicular to the microwave traveling direction were the x-axis direction and the y-axis direction, the orthogonal projection area of the surface (xy plane) expanding in the x-axis and the y-axis in the reaction portion when viewed in the z-axis direction was adjusted to be larger than each of the orthogonal projection areas of the surface (xz plane) expanding in the x-axis and the z-axis in the reaction portion when viewed in the y-axis direction and the surface (yz plane) expanding in the y-axis and the z-axis in the reaction portion when viewed in the x-axis direction.

### Comparative Example 1

In Example 1, except that the irradiation of the reaction solution with the microwaves was changed to irradiation of the reaction solution with the microwave by one side, namely, one irradiation source, the waveguide through which the microwave passed was installed such that the waveguide and the reaction solution overlapped linearly when viewed in the z-axis direction, and the microwave with the power density of 10 W/mL was absorbed based on the total volume of the reaction solution, Comparative Example 1 was performed similarly to Example 1.

2. Particle Size Distribution of Silver Nanoparticle Dispersion Liquid

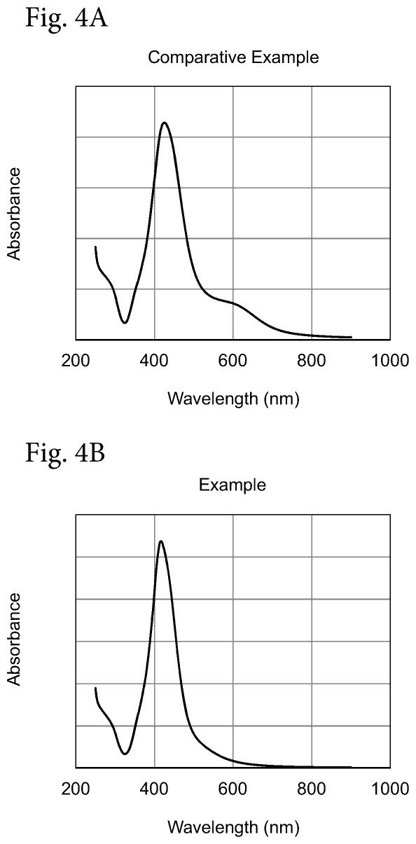

UV-vis absorption measurement was performed on the silver nanoparticles obtained by Example 1 and Comparative Example 1. FIG. 4A and FIG. 4B show the results.

It has been found from FIG. 4A and FIG. 4B that while the silver nanoparticles obtained in Example 1 had the small and uniform particle sizes, the silver nanoparticles obtained in Comparative Example 1 had the large and non-uniform particle sizes (that is, the absorbance peak existed also in the proximity of 600 nm). Accordingly, it has been found that, to produce the silver nanoparticles with the small and uniform particle sizes, when the microwave traveling direction is the z-axis direction and directions perpendicular to the microwave traveling direction are the x-axis direction and the y-axis direction, the configuration of the reaction portion needs to be configured such that the orthogonal projection area of the surface (xy plane) expanding in the x-axis and the y-axis in the reaction portion when viewed in the z-axis direction is larger than each of the orthogonal projection areas of the surface (xz plane) expanding in the x-axis and the z-axis in the reaction portion when viewed in the y-axis direction and the surface (yz plane) expanding in the y-axis and the z-axis in the reaction portion when viewed in the x-axis direction.

3. Simulation Experiment

Based on the apparatus illustrated in FIG. 3, in the apparatus to perform the present disclosure, when the microwave traveling direction was the z-axis direction and directions perpendicular to the microwave traveling direction were the x-axis direction and the y-axis direction, simulation to configure the orthogonal projection area of the surface (xy plane) expanding in the x-axis and the y-axis in the reaction portion when viewed in the z-axis direction to be larger than each of the orthogonal projection areas of the surface (xz plane) expanding in x-axis and the z-axis in the reaction portion when viewed in the y-axis direction and the surface (yz plane) expanding in the y-axis and the z-axis in the reaction portion when viewed in the x-axis direction was conducted.

The simulation method is described below.
(1) The distribution of the microwaves absorbed by the reaction solution was calculated in a microwave Sim (NSYS Electronics Desktop).
(2) Coupled analysis was performed on the calculation model with Fluent in by Workbench.
(3) The volume of each mesh and the power density of the microwave absorbed by each of the meshes were obtained with values by Fluent.

From the results of the simulation, it has been found that the two waveguides can be disposed from the positions where the two waveguides completely overlap with one another linearly (a structure in which the orthogonal projection area where the xy planes in the two waveguides overlap with one another becomes 100% with respect to the total orthogonal projection area of the xy plane formed by the two waveguides when viewed in the z-axis direction) to the positions where the surfaces (xy planes) expanding in the x-axis and the y-axis in the two waveguides just do not overlap with one another. Furthermore, it has been found that the two waveguides may be disposed such that the xy planes in the two waveguides partially overlap with one another (a structure in which the orthogonal projection area where the xy planes in the two waveguides overlap with one another becomes 12% to 51% with respect to the total orthogonal projection area of the xy planes formed by the two waveguides when viewed in the z-axis direction). It has been found that the orthogonal projection area of the xy plane in the reaction portion when viewed in the z-axis direction may be from 1% to 33% and especially 22% with respect to the irradiation orthogonal projection area of the microwaves irradiated from the two microwave irradiation sources to the reaction portion (the total orthogonal projection area of the xy plane formed by the two waveguides when viewed in the z-axis direction). The orthogonal projection area of the xy plane in the reaction portion when viewed in the z-axis direction was from 100 mm² to 3850 mm² and especially 2640 mm².

Additionally, it has been found that, as the shape of the reaction portion, a cylindrical body and a rectangular parallelepiped can be employed. Furthermore, it has been found that the shape of the reaction portion may be a cylindrical body.

All publications, patents and patent applications cited in the present description are herein incorporated by reference as they are.

What is claimed is:

1. A microwave irradiation apparatus comprising:
two microwave irradiation sources;
two waveguides; and
one reaction portion,
wherein the two microwave irradiation sources are disposed such that respective microwave emission units thereof face one another,
wherein the two microwave irradiation sources, the two waveguides, and the one reaction portion are disposed such that respective microwaves emitted from the two microwave irradiation sources pass through the two waveguides and contact an entire surface of the one reaction portion, and
wherein when a microwave traveling direction is a z-axis direction and directions perpendicular to the microwave traveling direction are an x-axis direction and a y-axis direction, an orthogonal projection area of a surface (xy plane) expanding in an x-axis and a y-axis in the reaction portion when viewed in the z-axis direction is larger than each of orthogonal projection areas of a surface (xz plane) expanding in the x-axis and a z-axis in the reaction portion when viewed in the y-axis direction and a surface (yz plane) expanding in the y-axis and the z-axis in the reaction portion when viewed in the x-axis direction.

2. The microwave irradiation apparatus according to claim 1,
wherein z-axis lengths of the xz plane and the yz plane in the reaction portion are twice or less of a penetration depth of one microwave into the reaction portion.

3. The microwave irradiation apparatus according to claim 1,
wherein the orthogonal projection area of the xy plane in the reaction portion is from 100 mm² to 3850 mm².

4. A method of producing metal nanoparticles including irradiating a reaction solution with a microwave, comprising:
(i) preparing two microwave irradiation sources and disposing respective microwave emission units of the two microwave irradiation sources such that the respective microwave emission units face one another;
(ii) disposing the reaction solution between the two microwave irradiation sources; and
(iii) irradiating an entire surface of the reaction solution with two microwaves from the two microwave irradiation sources by a batch type;
wherein when a microwave traveling direction is a z-axis direction and directions perpendicular to the microwave traveling direction are an x-axis direction and a y-axis direction, an orthogonal projection area of a surface (xy plane) expanding in an x-axis and a y-axis in the reaction portion when viewed in the z-axis direction is adjusted to be larger than each of orthogonal projection areas of a surface (xz plane) expanding in the x-axis and a z-axis in the reaction portion when viewed in the y-axis direction and a surface (yz plane) expanding in the y-axis and the z-axis in the reaction portion when viewed in the x-axis direction.

5. The method according to claim 4,
wherein the reaction solution is not physically stirred in (iii).

6. The method according to claim 4,
wherein z-axis lengths of the xz plane and the yz plane in the reaction solution are twice or less of a penetration depth of one microwave into the reaction solution in (iii).

7. The method according to claim 6,
wherein the orthogonal projection area of the xy plane in the reaction solution is from 100 mm² to 3850 mm² in (iii).
